(19) United States
(12) Patent Application Publication
(10) Pub. No.: US 2013/0139435 A1
(43) Pub. Date: Jun. 6, 2013

(54) ADJUSTABLE PLANT SUPPORT

(71) Applicants: Marvin Lewis Harrod, Pasco, WA (US); Eric Harrod, Pasco, WA (US); Cynthia Mulford, Eltopia, WA (US)

(72) Inventors: Marvin Lewis Harrod, Pasco, WA (US); Eric Harrod, Pasco, WA (US); Cynthia Mulford, Eltopia, WA (US)

(21) Appl. No.: 13/312,363

(22) Filed: Dec. 6, 2011

(51) Int. Cl. A01G 17/04

(52) U.S. Cl. 47/46

(57) ABSTRACT

An adjustable garden stake having a central stake. A T-structure having a vertical cylinder attached to a horizontal cylinder is disposed around the central stake. A thumbscrew is screwed into the vertical cylinder which is capable of holding the T-structure in a fixed position along the length of the central stake. A retainer ring is disposed about the central stake and is attached to each end of the horizontal cylinder of the T-structure.

### TECHNICAL FIELD

The present invention relates generally to garden stakes commonly used to provide support for growing plants and flowers and, more particularly, to adjustable garden stakes that may be adjusted easily to accommodate growth in the plants.

### BACKGROUND OF THE INVENTION

Garden stakes are commonly used to by gardeners to support growing plants and to protect them from wind and other disturbances. Wooden and metal stakes are commonly used as simple, straight supports. Twine, rope or string is also used in conjunction with such supports. Recent improvements to these simpler supports include stakes with a primary shaft and a foot adjustably secured to the primary shaft. The lower end of the shaft is configured for insertion into the soil at a first location. The upper end of the shaft is attached to a hoop wire attached on one edge to the primary shaft. However, the plant's weight may not be evenly distributed in such arrangements, which may cause the support to fail. Further, such garden stakes require custom machined components, and cannot be fabricated from readily available parts.

### BRIEF DESCRIPTION OF THE DRAWINGS

The following description of the of the invention will be more readily understood when taken in conjunction with the following drawing, wherein:

FIG. 1 is a drawing of the adjustable garden stake of the present invention.

FIG. 2 is drawing of the removable cap used in the present invention.

### SUMMARY OF THE INVENTION

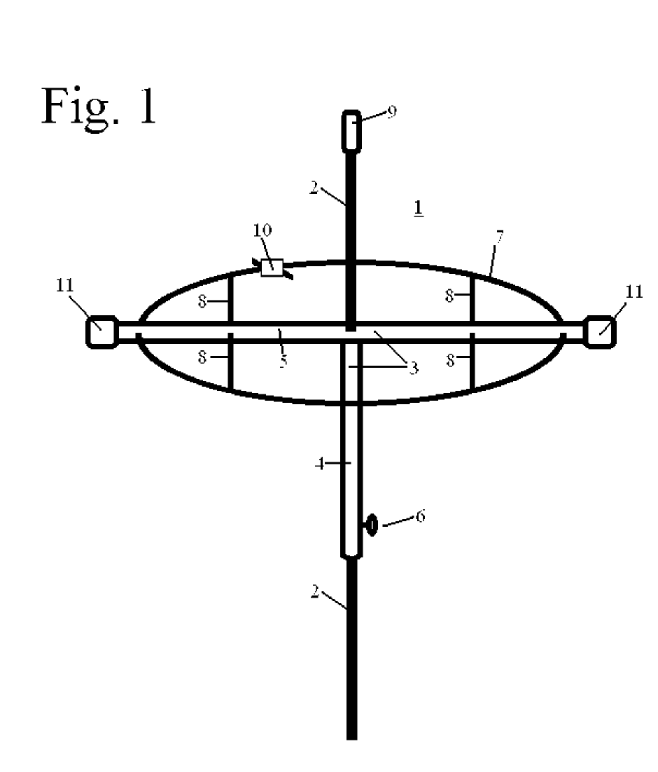

The drawbacks of currently available garden stakes are overcome by the present invention. As shown in FIG. 1., the present invention is an adjustable garden stake 1 having a central stake 2. A T-structure 3 having a vertical cylinder 4 is disposed around the central stake. The vertical cylinder 4 of the T-structure 3 is attached to a horizontal cylinder 5, which is disposed perpendicular to the central stake 2. A thumbscrew 6 is screwed into the vertical cylinder 4 which is capable of holding the T-structure 3 in a fixed position along the length of the central stake 2. A retainer ring 7 is disposed about the central stake 2 and is attached to each end of the horizontal cylinder 5 of the T-structure 3.

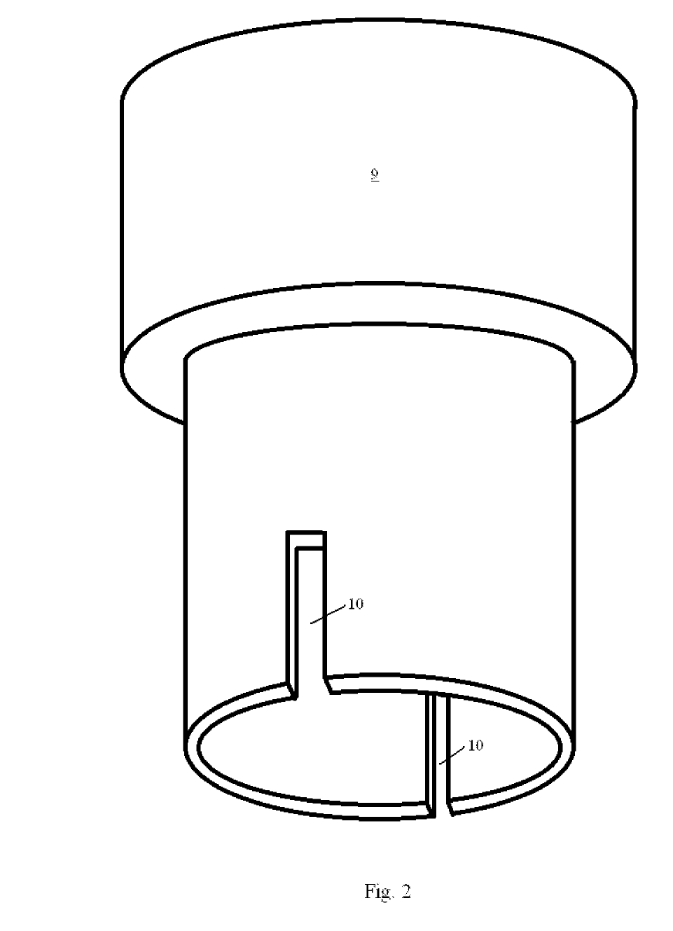

The adjustable garden stake 1 of the present invention may further utilize support rods 8 attached to the horizontal cylinder 5 and the retainer ring 7. The adjustable garden stake 1 of the present invention may also further utilize a removable cap 9. As shown in FIG. 1, the removable cap 9 preferably fits on top of the central stake 2. As shown in FIG. 2, the removable cap 9 preferably has a slot 10 such that the thumbscrew 6 may be inserted into the slot 10, thereby allowing the removable cap 9 to be used as a wrench to tighten or loosen the thumbscrew 6.

The adjustable garden stake 1 of the present invention may make use of end caps 11 disposed on each end of the horizontal cylinder 5. Without meaning to be limiting, the end caps 11 are used to prevent insects and other pests from nesting within the horizontal cylinder 5. The adjustable garden stake 1 of the present invention may make use of short sections of rubber hose 10 used to hold together ends of the retainer ring 7.

### DETAILED DESCRIPTION OF THE PREFERRED EMBODIMENTS

For the purposes of promoting an understanding of the principles of the invention, reference will now be made to specific embodiments and specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

One key advantage of the present invention is the ability to fabricate the adjustable garden stake of the present invention using inexpensive and readily available materials. For example, one specific embodiment was fabricated as follows, using materials that are readily procured at a typical American hardware store. In this embodiment, the adjustable garden stake 1 was built using a central stake 2 made of rebar steel rod. The T-structure was made of ½″ PVC for the horizontal portion and ½″ metal plumbing pipe for the vertical portion, held together with a ½″ threaded PVC t-joint. The retainer ring disposed about the central stake was made from number 9 galvanized wire. The ends of the retainer ring were held together with a short section of 5/16″ external diameter and 3/16″ internal diameter hose. The support rods were made of 22″ hot rolled steel bars. The removable cap was made of ½″ PVC. The thumbscrew was screwed into a threaded hole drilled in the side of the metal plumbing pipe. The end caps were standard PVC end caps on each end of the horizontal cylinder of the T-structure.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. Any experiments, experimental examples, or experimental results provided herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Likewise, where the term “input” or “output” is used in connection with an electric device or fluid processing unit, it should be understood to comprehend singular or plural and one or more signal channels or fluid lines as appropriate in the context. Finally, all publications, patents, and patent applications cited in this specification are herein incorporated by reference to the extent not inconsistent with the present disclosure as if each were specifically and individually indicated to be incorporated by reference and set forth in its entirety herein.

We claim:

1. An adjustable garden stake comprising,
a central stake,
a T-structure having a vertical cylinder slidably disposed around the central stake attached to a horizontal cylinder disposed perpendicular to the central stake, the vertical cylinder having a threaded aperture,
a thumbscrew screwed into the threaded aperture capable of holding the T-structure in a fixed position along the length of the central stake,
a retainer ring disposed about said central stake and attached to each end of the horizontal cylinder of the T-structure,
support rods attached to the horizontal cylinder and the retainer ring,
a removable cap fitting on top of the central stake, the removable cap having a slot such that the thumbscrew may be inserted into the slot, thereby providing the cap as a wrench to tighten or loosen the thumbscrew.

2. The apparatus of claim 1 further comprising end caps disposed on each end of the horizontal cylinder.

3. The apparatus of claim 1 further comprising a section of rubber hose disposed to hold the ends of retainer ring together.

4. An adjustable garden stake comprising,
a central stake,
a T-structure having a vertical cylinder slidably disposed around the central stake attached to a horizontal cylinder disposed perpendicular to the central stake,
a thumbscrew screwed into the vertical cylinder capable of holding the T-structure in a fixed position along the length of the central stake,
a retainer ring disposed about said central stake and attached to each end of the horizontal cylinder of the T-structure,
support rods attached to the horizontal cylinder and the retainer ring,
a removable cap fitting on top of the central stake, the removable cap having a slot such that the thumbscrew may be inserted into the slot, thereby providing the cap as a wrench to tighten or loosen the thumbscrew.

5. The apparatus of claim 4 further comprising a threaded aperture in the vertical cylinder wherein the thumbscrew may be screwed into the threaded aperture.

6. The apparatus of claim 4 further comprising end caps disposed on each end of the horizontal cylinder.

7. The apparatus of claim 4 further comprising a section of rubber hose disposed to hold the ends of retainer ring together.

8. An adjustable garden stake comprising,
a central stake,
a T-structure having a vertical cylinder slidably disposed around the central stake made of rebar attached to a horizontal cylinder disposed perpendicular to the central stake,
a thumbscrew screwed into the vertical cylinder capable of holding the T-structure in a fixed position along the length of the central stake,
a retainer ring disposed about said central stake and attached to each end of the horizontal cylinder of the T-structure.

9. The apparatus of claim 8 further comprising support rods attached to the horizontal cylinder and the retainer ring.

10. The apparatus of claim 8 further comprising a removable cap fitting on top of the central stake, the removable cap having a slot such that the thumbscrew may be inserted into the slot, thereby allowing the cap to be used as a wrench to tighten or loosen the thumbscrew.

11. The apparatus of claim 8 further comprising a threaded aperture in the vertical cylinder wherein the thumbscrew may be screwed into the threaded aperture.

12. The apparatus of claim 8 further comprising end caps disposed on each end of the horizontal cylinder.

13. The apparatus of claim 8 further comprising a section of rubber hose disposed to hold the ends of retainer ring together.
